(19) United States
(12) Patent Application Publication
(10) Pub. No.: US 2008/0127906 A1
(43) Pub. Date: Jun. 5, 2008

(54) Animal restraint apparatus

(76) Inventors: Stuart J. Williams, Friendswood, TX (US); Robert L. Schwebel, Lake Jackson, TX (US)

Correspondence Address: NICK A NICHOLS, P O BOX 16399, SUGARLAND, TX, 774966399, US

(21) Appl. No.: 10/941,641

(22) Filed: Sep. 14, 2004

Related U.S. Application Data
(60) Provisional application No. 60/503,044, filed on Sep. 15, 2003.

(51) Int. Cl. A61D 3/00; A01K 1/06; A01K 15/00; A01K 15/04

(52) U.S. Cl. 119/733

(57) ABSTRACT

An animal restraint apparatus includes a base having a fixed side extending upward from the base and a movable side secured to the base spaced from and facing the fixed side of the apparatus. The front end of the apparatus includes transverse panels defining an opening for the head and neck of an animal to extend through. The fixed and movable sides of the apparatus support side panels for engaging an animal positioned within the apparatus. The rear end of the apparatus is provided with a gate pivotally mounted on the apparatus frame.

### CROSS-REFERENCE TO RELATED APPLICATION

This application claims the benefit of U.S. Provisional Application Ser. No. 60/503,044, filed Sep. 15, 2003, which application is incorporated herein by reference.

### BACKGROUND OF THE DISCLOSURE

The present invention relates generally to animal restraint apparatus, and more particularly to an improved animal restraint apparatus designed to gently restrain an animal while simultaneously calming the animal. The apparatus is designed primarily for veterinary use for temporarily restraining animals undergoing various veterinary procedures.

Various animal restraint means such as cages, pens, squeeze chutes and the like are known in the prior art. These devices, while effective in confining the animal, tend to increase the animal's fear and often make it more difficult to handle the animal. Furthermore, an animal's ability to recall may render the animal difficult to effectively restrain on subsequent or repeat occasions when the animal must be restrained for undergoing procedures wherein invasive devices, such as needles or the like, must be used.

It is known that applied pressure has a calming effect. In recent years research with autistic children has shown that pressure therapy has been remarkably successful in calming an autistic child. Likewise, immobilizing pressure applied to an animal tends to provide a calming effect.

While it is important that an individual attending to an animal is protected from harm, it is equally important that the animal is not injured or hurt while undergoing a veterinary procedure. This may be extremely difficult to do without sedating the animal, particularly for animals having rowdy or generally uncontrollable dispositions. A need therefore exists for an animal restraint apparatus which restrains the animal while at the same time calming the animal.

It is therefore an object of the present invention to provide an animal restraint apparatus for restraining and calming an animal while undergoing typical veterinary procedures.

It is another object of the present invention to provide an animal restraint apparatus adapted for restraining animals of various sizes and dispositions.

It is yet another object of the present invention to provide an animal restraint apparatus which is portable and simple to operate.

### SUMMARY OF THE INVENTION

In accordance with the present invention, the animal restraint apparatus of the invention includes a frame, preferable fabricated of metal tubing. The frame includes a base having a fixed side extending upward from the base and a movable side secured to the base spaced from and facing the fixed side of the apparatus. The front end of the apparatus includes transverse panels defining an opening for the head and neck of the animal to extend through. The fixed and movable sides of the apparatus support soft side panel cushions for engaging the animal positioned within the apparatus. The rear end of the apparatus is provided with a gate pivotally mounted on the apparatus frame.

### BRIEF DESCRIPTION OF THE DRAWINGS

So that the manner in which the above recited features, advantages and objects of the present invention are attained can be understood in detail, a more particular description of the invention briefly summarized above, may be had by reference to the embodiments thereofwhich are illustrated in the appended drawings.

It is noted, however, that the appended drawings illustrate only typical embodiments of this invention and are therefore not to be considered limiting of its scope, for the invention may admit to other equally effective embodiments.

FIG. 1 is an end view of the animal restraint apparatus of the invention;

FIG. 2 is a side view of the animal restraint apparatus of the invention partially broken away to show the slide mechanism for the movable frame member of the invention;

FIG. 3 is an end view of the animal restraint apparatus of the invention depicting the gate of the invention pivotally mounted on the fixed frame member of the apparatus;

FIG. 4 is a side of the animal restraint apparatus of the invention opposite the view shown in FIG. 2;

FIG. 5 is a section view of the animal restraint apparatus of the invention showing the movable frame member of the apparatus in a open position; and

FIG. 6 is a section view of the animal restraint apparatus of the invention illustrating use of the apparatus with an animal positioned therein.

### DETAILED DESCRIPTION OF A PREFERRED EMBODIMENT

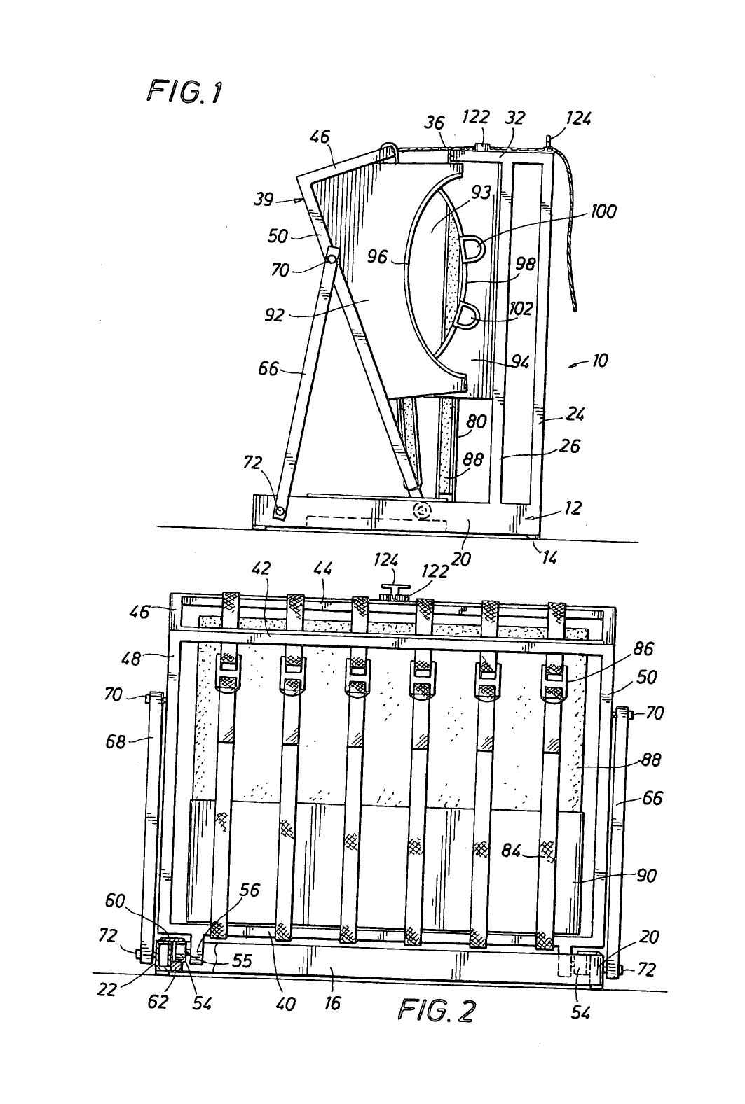

Referring first to FIG. 1, the animal restraint apparatus of the invention is generally identified by the reference numeral 10. The apparatus 10 is a generally rectangular open frame preferably fabricated of metal tubing. The apparatus 10 includes a base 12 which is provided with casters 14 at the corners thereof for conveniently sliding the apparatus 10 over a floor or other surface. The base 12 defines an open rectangular structure formed by side members 16 and 18, and front and rear end members 20 and 22.

A pair of side walls extending upward from the base 12 provide lateral restraint for an animal positioned within the apparatus 10. A fixed side wall 23 is formed by vertical frame members 24, 26, 28 and 30. The vertical frame members of the fixed side wall 23 are welded or otherwise fixed to the base 12. Fixed frame members 24 and 26 are secured to the front end member 20 of the base 12. The fixed frame members 28 and 30 are likewise secured to the rear end member 22 of the base 12. Frame members 24 and 28 are spaced from frame members 26 and 30, and are in respective alignment therewith. Horizontal frame members 32, 34, 36 and 38 secured to the upper distal ends of the vertical frame members 24, 26, 28 and 30 complete the open fixed side wall 23 of the apparatus 10.

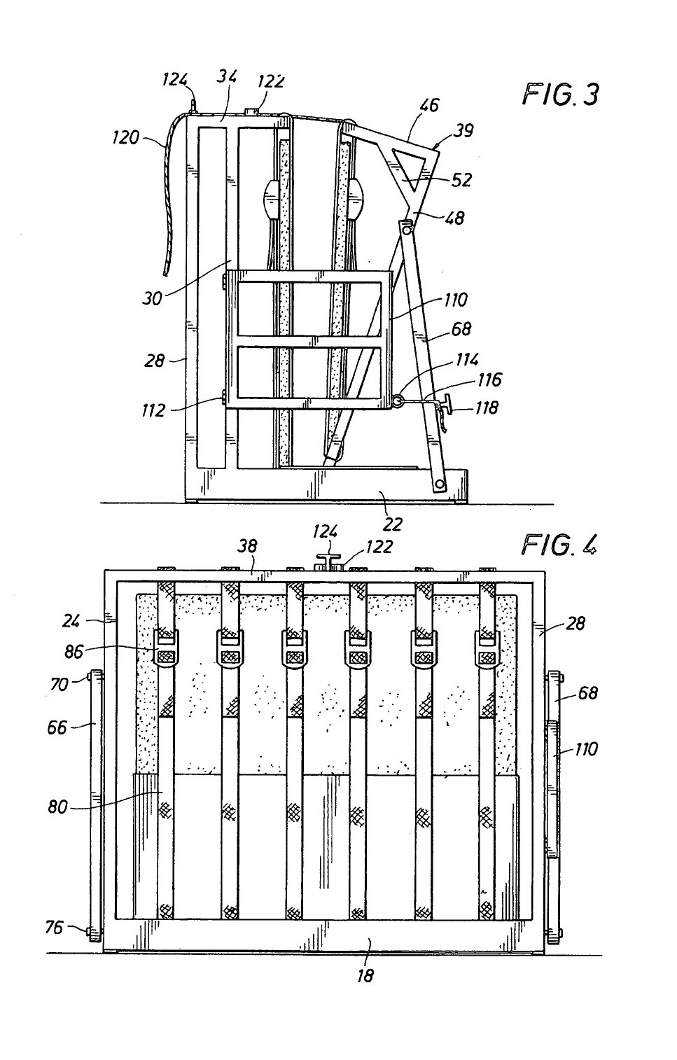

Referring now to FIGS. 1 and 2, the movable side wall of the apparatus 10 comprises a substantially L-shaped (in end view) frame 39 defined by a lower horizontal frame member 40 and upper horizontal frame members 42, 44 and 46, interconnected by vertical frame members 48 and 50. Additional stability is provided by angular brace members 52 secured between horizontal frame members 46 and vertical frame members 48 and 50, as best shown in FIG. 3. The lower end of the movable side wall 39 is provided with roller wheels 54 at the opposite ends thereof for slideably mounting the lower end of the movable side wall 39 to the base 12 of the apparatus 10. The whells 54 are mounted on roller pins 55 projecting from mounting posts 56 depending downwardly from the horizontal frame member 40. The wheels 54 are received in wheel channels formed on the interior surfaces of the end members 20 and 22 of the base 12.

The wheels 54 are retained between upper flange members 60 and lower flange members 62 secured to the base members 20 and 22 along a portion of the length thereof. The flange members 60 and 62 form the open wheel channel tracks for the wheels 54. The wheel channel tracks are sufficiently deep so that the wheels 54 are retained therein and do not disengage the channel tracks when the restraint apparatus 10 is in use.

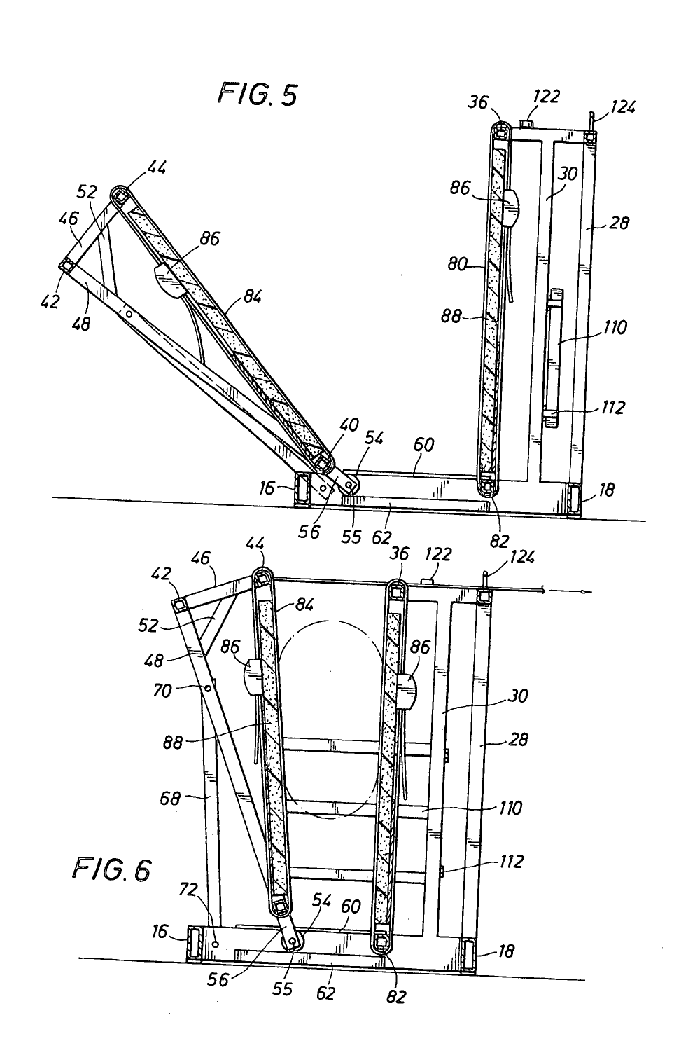

Referring again to FIG. 2, elongate arms 66 and 68 pivotally secure the side wall frame 39 to the base 12 of the apparatus 10. Pivot pins 70 and 72 connect opposite ends of the pivot arms 66 and 68 to the frame members 48 and 50 and the base members 20 and 22. The arms 66 and 68 form a pivot linkage arrangement for the side wall frame 39 which permits the side wall 39 to rotate outwardly, as shown in FIG. 5, so that an animal may enter the apparatus 10. The side wall 39 rotates about the pivot pins 72 outward to an angle of about 45° from vertical. Once an animal is positioned in the apparatus 10, the side wall 39 is rotated upward about the pivot linkage and simultaneously moves laterally inward on the wheels 54 to position the side wall 39 up against the animal, as shown in FIG. 6. It will be observed that in the closed position, the side wall 39 is substantially vertical and parallel to the fixed side wall 23 of the apparatus 10.

Referring still to FIGS. 5 and 6, the side walls of the apparatus 10 are provided with a plurality of straps 80 extending about frame member 36 of the fixed side wall 23 and a frame member 82 extending between frame members 20 and 22 of the base 12. A plurality of straps 84 likewise extend about the frame members 40 and 44 of the side wall 39. The straps 80 and 84 are substantially equally spaced and aligned along the side wall frame members of the apparatus 10. Each of the straps 80 and 84 include buckles 86 for loosening or tightening the straps 80 and 84 about the side walls 23 and 39 of the apparatus 10.

The straps 80 and 84 form a flexible webbing for supporting foam panels 88, as best shown in FIGS. 2 and 4. The panels 88 are preferably fabricated of high density foam or similar material and slide between the aligned straps 80 and 84 on the side wall frame members 23 and 39 of the apparatus 10. Rigid panels 90, preferably fabricated of a plastic material or the like, are also positioned between the aligned straps 80 and 84 against the outer lower surface of the foam panels 88. The rigid panels 90 cover about a third of the lower surface area of the foam panels 88 and provide a rigid wall surface along the lower surface of the panels 88. An animal positioned in the apparatus 10 is therefore prevented from kicking or extending its feet outside of the side walls 23 and 39 of the apparatus 10. The foam panels 88 and the rigid panels 90 may, however, be pulled back and forth between the straps 80 and 84 providing access to the animal for examination and medical treatment.

Referring again to FIG. 1, the forward end of the apparatus 10 is provided with opposed plates 92 and 94 on the frame members 46 and 50 of the side wall 39 and the frame members 26 and 32 of the fixed side wall 23, respectively. The plates 92 and 94 include oppositely located cut out portions defined by curved padded edges 96 and 98. In the closed position, the upper and lower portions of the plates 92 and 94 overlap so that the opposed edges 96 and 98 of the plates 92 and 94 form an opening 93 for the head and neck of an animal to extend through the neck opening 93. The plate 94 further includes a pair of openings 100 and 102. The openings 100 and 102 provide holes for a leash or other retraint means secured to the animal to aid in holding the animal in the apparatus 10 with its head extending through the neck opening 93 formed by the plates 92 and 94.

The rear end of the apparatus 10 is closed by a gate 110. The gate 110 is hingedly secured to the fixed frame member 30 by hinges 112. A pad-eyed connector 114 welded or otherwise secured to the gate 110 provides a connection point for one end of a rope 116 or the like. The gate 110 is closed after the animal is inside the apparatus 10 and secured by tying the free end of the rope 116 about a cleat 118 located on the pivot arm 68 of the side wall frame 39.

In use, the apparatus 10 of the invention is initially in the open position shown in FIG. 5. The animal, such as a dog, is walked into the apparatus 10 and positioned next to the fixed side wall 23. Depending on the size of the animal, its leash is threaded through the upper or lower openings 100, 102 in the neck plate 94 so that the animal's neck is positioned within the neck opening 93. The opposite side wall frame 39 is rotated and laterally moved against the side of the animal as shown in FIG. 6. A rope 120 connected at one end to the side wall frame 39 is pulled through a cam cleat 122 mounted on frame member 36 and tied to an anchor cleat 124 mounted on frame member 38 of the fixed side wall 23. The side wall 39 is pulled firmly so that the foam panels 80 and 84 press snugly against the animal and provide an immobilizing force about the animal. The applied pressure against the animal produces a calming effect and the animal is much more manageable during the examination procedure.

While a preferred embodiment of the invention has been shown and described, other and further embodiments of the invention may be devised without departing from the basic scope thereof, and the scope thereof is determined by the claims which follow.

1. An apparatus for restraining animals, comprising:
a) an open frame structure having a base, openable front and rear ends, and sidewalls defining an internal chamber;
b) said sidewalls comprising a fixed sidewall extending upward from said base and a moveable sidewall pivotally connected to said base; and
c) side panels supported by said fixed sidewall and said moveable sidewall.

2. The apparatus of claim 1 wherein said front end includes opposed plates mounted on said sidewalls, said plates including opposed arcuate edges defining an opening upon closing said moveable sidewall against said fixed sidewall.

3. The apparatus of claim 2 wherein said moveable sidewall includes wheels depending from a lower end thereof, said wheels being received in open channel tracks mounted on said base.

4. The apparatus of claim 1 including a web structure supported on said sidewalls, said web structure adapted for receiving and supporting said side panels.

5. The apparatus of claim 4 wherein said side panels include a first set of side panels fabricated of foam material.

6. The apparatus of claim 5 wherein said side panels include a second set of side panels fabricated of rigid material supported by said web structure adjacent to a lower external surface of said first set of panels.

7. The apparatus of claim 4 wherein said web structure is formed by a plurality of straps secured on said sidewalls.

8. The apparatus of claim 1 wherein said rear end of said open frame structure is closed by a gate pivotally mounted on said fixed sidewall.

9. The apparatus of claim 1 including means for securing said sidewalls in a closed position.

10. The apparatus of claim 1 wherein said moveable sidewall is adapted for pivotal rotation and lateral movement upon closing and opening said open frame structure.
